(19) United States
(12) Patent Application Publication
(10) Pub. No.: US 2021/0232153 A1
(43) Pub. Date: Jul. 29, 2021

(54) TRAVELING BODY, TRAVELING SYSTEM AND TRAVELING CONTROL METHOD

(71) Applicant: SHARP KABUSHIKI KAISHA, Osaka (JP)

(72) Inventor: SHOTA INOUE, Osaka (JP)

(21) Appl. No.: 17/157,247

(22) Filed: Jan. 25, 2021

(30) Foreign Application Priority Data
Jan. 27, 2020 (JP) 2020-010690

(51) Int. Cl. G05D 1/02; B61B 13/00

(52) U.S. Cl. CPC G05D 1/0263; B61B 13/00

(57) ABSTRACT

A traveling body has a position detector, a traveling controller, and a determination processor. The position detector detects a position of the traveling body while the traveling body travels. The traveling controller switches between a first traveling method and a second traveling method. In the first traveling method, the traveling body is traveled along a guide member, by detecting the guide member laid on the traveling route, whereas in the second traveling method, the traveling body is traveled based on the position detected by the position detector without depending on the guide member. The determination processor determines a detection state of the guide member. The traveling controller switches from the first traveling method to the second traveling method, when the determination processor determines that the guide member is in a detection state in which the traveling body cannot travel by the first traveling method.

### INCORPORATION BY REFERENCE

This application is based upon and claims the benefit of priority from the corresponding Japanese Patent Application No. 2020-010690 filed on Jan. 27, 2020, the entire contents of which are incorporated herein by reference.

The present disclosure relates to a traveling body, a traveling body system, and a traveling control method for controlling the traveling body.

### BACKGROUND

Conventionally, transport cars (traveling bodies) that transport packages (articles) such as goods and parts have been used in warehouses, manufacturing lines, etc. For example, an operator takes out a desired package from a storage shelf in which packages are stored, and loads it on a transport car. The transport car travels along a preset traveling route, and transports the package to a desired position (delivery exit, etc.). For example, a transport car travels toward a destination while detecting a magnetic tape (an example of a guide member) laid on the traveling route.

When the transport car is derailed from the magnetic tape, a problem is that the transport car cannot travel on the set traveling route. Conventionally, as a technology for solving the above-mentioned problem, a technology has been proposed in which the wheel unit of the transport car is swung to search for the magnetic tape and return from the derailment, when the transport car is derailed from the magnetic tape.

However, in accordance with the conventional technology, the transport car cannot return from the derailment, or it takes much time for return, because it is not possible to grasp the situation in which the transport car has been derailed from the magnetic tape.

### SUMMARY

An object of the present disclosure is to provide a traveling body, a traveling system, and a traveling control method capable of efficiently returning the traveling body when the traveling body that detects the guide member to travel has been derailed from the guide member.

According to one aspect of the present disclosure, there is provided a traveling body comprising: a position detector that detects a position of the traveling body while the traveling body is traveling; a traveling controller that switches between a first traveling method in which the traveling body is made to travel along a guide member laid on a traveling route by detecting the guide member and a second traveling method in which the traveling body is made to travel based on the position detected by the position detector without depending on the guide member; and a determination processor that determines a detection state of the guide member, wherein when the determination processor determines that the detection state of the guide member is a state in which the traveling body cannot travel by the first traveling method, the traveling controller switches from the first traveling method to the second traveling method.

According to another aspect of the present disclosure, there is provided a traveling system comprising: a position detector that detects a position of a first traveling body while the first traveling body is traveling along a guide member laid on a traveling route; a determination processor that determines whether or not the first traveling body has been derailed from the guide member; a traveling controller that controls the first traveling body to return to a position of the guide member, when the determination processor determines that the first traveling body has been derailed from the guide member; and an output processor that outputs information regarding a derailment position where the first traveling body has been derailed from the guide member and an instruction to switch to low-speed traveling, to a second traveling body following the first traveling body, when the determination processor determines that the first traveling body has been derailed from the guide member.

According to still another aspect of the present disclosure, there is provided a traveling control method to be executed by one or a plurality of processors, the method comprising: detecting a position of a traveling body while the traveling body is traveling; controlling switching between a first traveling method for traveling the traveling body along a guide member laid on a traveling route by detecting a guide member and a second traveling method for traveling the traveling body based on the position detected by the detecting without depending on the guide member; and determining a detection state of the guide member, wherein in the controlling, when it is determined by the determining that the detection state of the guide member is a state in which the traveling body cannot travel by the first traveling method, the first traveling method is switched to the second traveling method.

According to the present disclosure, it is possible to provide a traveling body, a traveling system, and a traveling control method, capable of efficiently returning the traveling body when the traveling body that detects the guide member to travel is derailed from the guide member.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an external perspective view showing a traveling body according to an embodiment of the present disclosure.

FIG. 2 is a functional block diagram showing a configuration of a traveling body according to an embodiment of the present disclosure.

FIG. 3 is a diagram showing an example of position information used in the traveling body according to the embodiment of the present disclosure.

FIG. 4 is a diagram showing an example of an environment map and a traveling route, used in the traveling body according to the embodiment of the present disclosure.

FIG. 5A is a diagram showing an example of a traveling state of the traveling body according to the embodiment of the present disclosure.

FIG. 5B is a diagram showing an example of a traveling state of the traveling body according to the embodiment of the present disclosure.

FIG. 5C is a diagram showing an example of a traveling state of the traveling body according to the embodiment of the present disclosure.

FIG. 5D is a diagram showing an example of a traveling state of the traveling body according to the embodiment of the present disclosure.

FIG. 6 is a flowchart showing an example of the procedure of a traveling control process executed in the traveling body according to the embodiment of the present disclosure.

FIG. 7A is a diagram showing an example of an obstacle detection range for the traveling body according to the embodiment of the present disclosure.

FIG. 7B is a diagram showing an example of an obstacle detection range for the traveling body according to the embodiment of the present disclosure.

FIG. 8 is a functional block diagram showing a configuration of a traveling system according to the embodiment of the present disclosure.

FIG. 9 is a diagram showing an example of a traveling state of each traveling body in the traveling system according to the embodiment of the present disclosure.

FIG. 10 is a diagram showing an example of an obstacle detection range of each traveling body in the traveling system according to the embodiment of the present disclosure.

### DETAILED DESCRIPTION

Preferred embodiments of the present disclosure will hereinafter be described with reference to the accompanying drawings. The following embodiments each represent an example of implementing the present disclosure, and is not of a nature to limit the technical scope of the present disclosure.

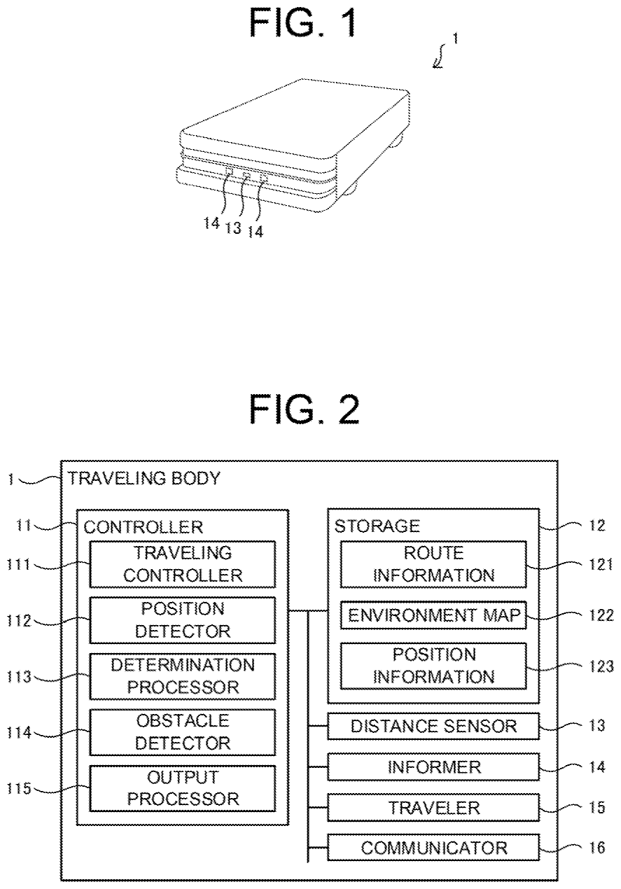

FIG. 1 is an external perspective view of the traveling body according to the embodiment of the present disclosure, and FIG. 2 is a functional block diagram showing a configuration of the traveling body according to the embodiment of the present disclosure. The traveling body 1 is, for example, an automatic guided vehicle capable of unmanned traveling. Further, the traveling body 1 has a configuration capable of switching between a magnetic-tape traveling method (an example of the first traveling method of the present invention) and a guideless traveling method (an example of the second traveling method of the present invention). The magnetic-tape traveling method is for traveling the traveling body 1 on a preset traveling route while detecting a magnetic tape (an example of a guide member of the present invention). The guideless traveling method is for autonomously traveling the traveling body 1 on the traveling route while detecting the current position without depending on the tape. The traveling body 1 is an example of the traveling body of the present invention.

As shown in FIG. 2, the traveling body 1 includes a controller 11, a storage 12, a distance sensor 13, an informer 14, a traveler 15, and a communicator 16. The traveling body 1 can communicate with an external device via a communication network such as the Internet, LAN, WAN, or public telephone line. For example, the traveling body 1 may be configured to be communicable with an operation terminal (not shown) via the communication network. That is, the traveling body 1 may be configured with a remotely controllable system that causes the traveling body 1 to travel based on the operator's operation on the operation terminal.

The communicator 16 is a communication interface, for connecting the traveling body 1 with the communication network by wire or wirelessly and executing data communication according to a predetermined communication protocol with an external device such as an operation terminal via the communication network.

The traveler 15 is a driver for causing the traveling body 1 to travel. The traveler 15 includes a drive motor, drive wheels, and the like. The traveler 15 controls the drive motor to drive in response to an instruction from the controller 11, to cause the traveling body 1 to travel.

The informer 14 informs the outside about the specified information. For example, the informer 14 is composed of a speaker, and outputs a predetermined sound to the outside. The informer 14 is composed of an indicator light (rotating light), and may output a predetermined light (lighting) to the outside. Further, the informer 14 is composed of a display panel, and may display a predetermined message on the display panel. Further, the informer 14 may be composed of at least two members, of the speaker, the indicator light, and the display panel.

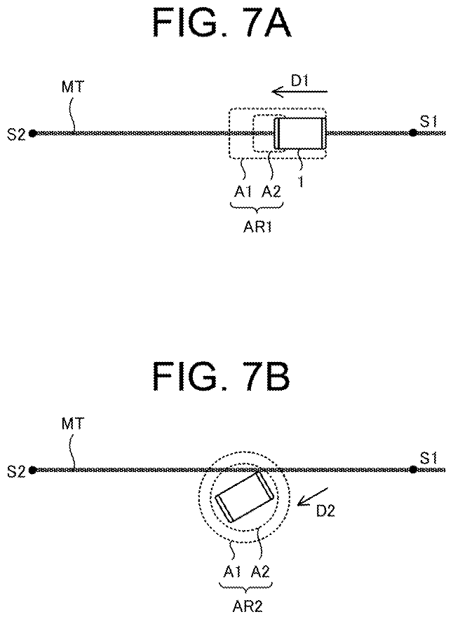

The distance sensor 13 measures the presence or absence of obstacles and the distance to the obstacles in a predetermined obstacle detection range AR (see FIG. 7, etc.). Specifically, the distance sensor 13 measures the distance by irradiating the obstacle detection range AR with the exploring light and detecting the reflected light. The distance sensor 13 measures the distance at a predetermined cycle. In this embodiment, laser light is used as the distance sensor 13. At least one distance sensor 13 is installed on the front side of the traveling body 1 in the traveling direction (see FIG. 1). The number of the distance sensors 13 is not limited, and at least one distance sensor 13 may be installed. In this embodiment, the distance sensor 13 installed on the front side in the traveling direction irradiates the laser light in a range of about 180 degrees, to measure the distance to obstacles (shelf, package, wall, pillar, operator, etc.) existing in the obstacle detection range AR. The distance sensor 13 measures the distance at a predetermined cycle, and outputs the measurement result to the controller 11.

The distance sensor 13 may measure the presence or absence of an obstacle (object) and the distance to the obstacle, using ultrasonic waves. Further, the traveling body 1 may measure the distance based on an image captured by a camera (not shown).

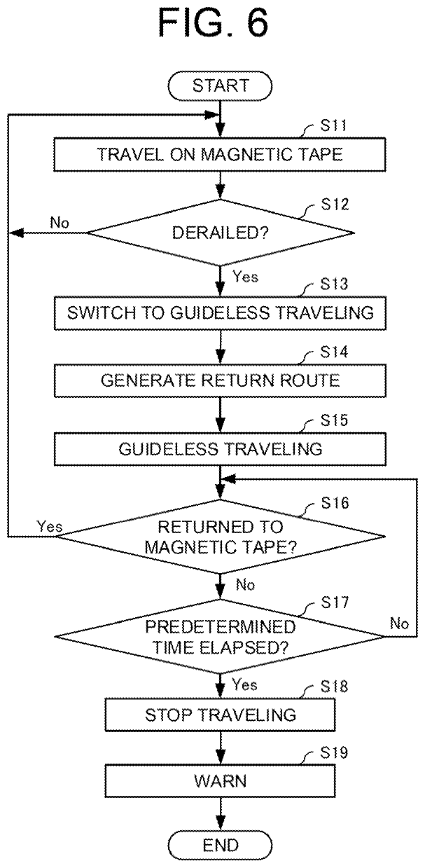

The storage 12 is a non-volatile storage including a semiconductor memory, HDD (Hard Disk Drive), SSD (Solid State Drive), etc. that stores various types of information. For example, the storage 12 stores a control program, such as a traveling control program, for causing the controller 11 to execute a traveling control process, as will be described below (see FIG. 6). The traveling control program is non-temporarily recorded on a computer-readable recording medium such as a USB, a CD or a DVD, and is stored in the storage 12 after being read by a reading device (not shown), such as a USB drive, a CD drive or a DVD drive included in the traveling body 1. Further, the traveling control program may be downloaded from an external device via a communication network and stored in the storage 12.

In addition, picking information is stored in the storage 12. The picking information indicates at which position and on which storage shelf each package to be transported is placed, and also indicates, of the packages, which package is to be transported, how many packages are to be transported and where they are to be transported. The storage 12 stores package information regarding packages. The package information indicates the quantity of packages stored in the storage shelf, the weight, volume, etc. of each package.

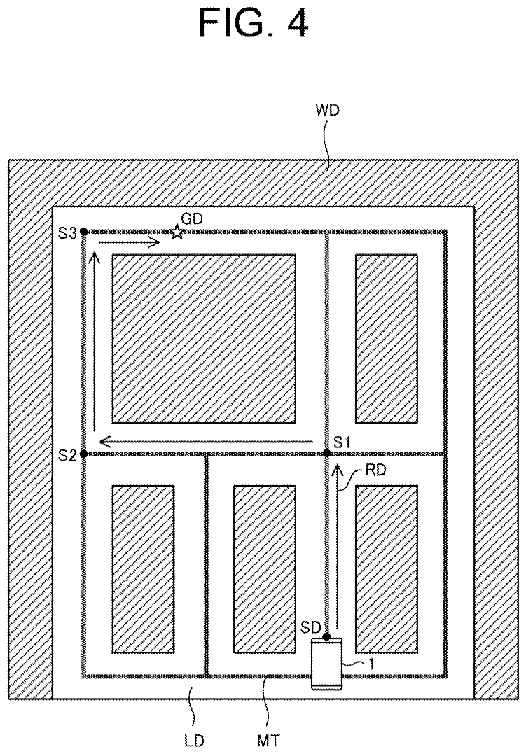

In addition, the storage 12 stores information necessary for the traveling body 1 to travel. For example, the storage 12 stores route information 121 representing a traveling route RD (see FIG. 4) on which the traveling body 1 travels. The traveling route RD is generated by the controller 11 in accordance with the setting information set by the operator (as will be described later).

In addition, the storage 12 stores data of an environment map 122 showing the environment of the range (traveling area) in which the traveling body 1 travels. The environment map 122 includes information about: a traveling route LD (passage) on which the traveling body 1 can travel; a fixed obstacle WD, such as a shelf, a wall, and a pillar; and a magnetic tape MT laid on the traveling route LD (See FIG. 4). The storage 12 stores the environment map 122 according to the place where the traveling body 1 is used. In this embodiment, an example is given for a case where the traveling body 1 is used in a place corresponding to the environment map 122 shown in FIG. 4. The magnetic tape MT is laid on the center of all the traveling routes LD, for example.

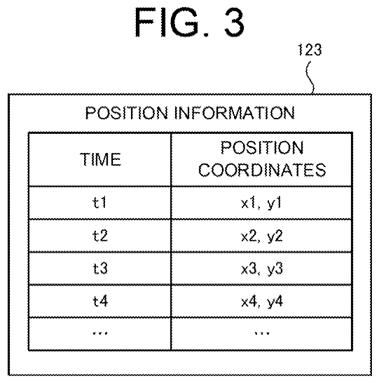

Further, the storage 12 stores data of position information 123 representing the position (current position) of the traveling body 1 while the traveling body 1 is traveling. FIG. 3 shows an example of position information 123. While the traveling body 1 is traveling, the controller 11 detects the position of the traveling body 1 by a well-known self-position estimation method, and registers it in the position information 123. The position information 123 has the detected position information registered (coordinate information, etc.) at predetermined time intervals.

The controller 11 has control devices such as a CPU, a ROM, and a RAM, etc. The CPU is a processor that executes various arithmetic processes. The ROM is a non-volatile storage in which control programs such as the BIOS and OS for causing the CPU to execute various arithmetic processes are stored in advance. The RAM is a volatile or non-volatile storage that stores various types of information, and is used as a temporary storage memory (working area) for various types of processes executed by the CPU. Further, the controller 11 controls the traveling body 1 by controlling the CPU to execute various control programs stored in advance in the ROM or the storage.

Specifically, as shown in FIG. 2, the controller 11 includes various processors, such as a traveling controller 111, a position detector 112, a determination processor 113, an obstacle detector 114, and an output processor 115. The controller 11 functions as the various processors as a result that the CPU executes the various processes according to the control programs. Moreover, some or all of the processors may be configured with an electronic circuit. The traveling control program may be a program for causing a plurality of processors to function as the above-mentioned processors.

The controller 11 generates (plans) the traveling route RD of the traveling body 1. For example, the controller 11 generates the traveling route RD in the environment map 122 based on the setting information that the operator assigns to the traveling body 1. The setting information includes, for example, point information and route information. This point information represents a traveling start point, a through-point, and a destination point or the like of the traveling body 1. The route information represents a route on which the traveling body 1 can travel and a route on which the travelling of the traveling body 1 is prohibited.

FIG. 4 shows an example of the traveling route RD. In FIG. 4, a sign SD represents the traveling start point, signs S1 to S3 represent points where the traveling direction changes, such as intersections and corners, etc., and a sign GD represents the destination point. The arrow with the sign RD represents the traveling route from the traveling start point SD to the destination point GD. The traveling route RD shown in FIG. 4, after the traveling body 1 departs from the traveling start point SD, goes straight and turns left at an intersection S1 (crossroad), goes straight and turns right at an intersection S2 (T-junction), then goes straight and turns right at a corner S3, and then arrives at the destination GD. The controller 11 stores the route information 121 including the generated traveling route RD, in the storage 12.

The traveling controller 111 controls the traveling operation of the traveling body 1. The traveling controller 111 is an example of the traveling controller of the present disclosure. Specifically, the traveling controller 111 detects the magnetic tape MT (see FIG. 4) laid on the traveling route LD, thereby causing the traveling body 1 to travel by a magnetic-tape traveling method for controlling the traveling body 1 to travel along a magnetic tape MT. For example, the traveling controller 111 outputs a traveling instruction according to the traveling route RD included in the route information 121 to the traveler 15 of the traveling body 1, while detecting magnetism from the magnetic tape MT. Further, the traveling controller 111 switches between the magnetic-tape traveling method and the guideless traveling method. In the guideless traveling method, the traveling controller 111 outputs a traveling instruction according to the traveling route RD to the traveler 15 of the traveling body 1, based on the current position (position information 123) of the traveling body 1, the route information 121, and the environment map 122. The traveler 15 drives a drive motor in response to the traveling instruction, to travel the traveling body 1.

The position detector 112 detects the position of the traveling body 1 while the traveling body 1 is traveling. Specifically, the position detector 112 detects the position of the traveling body 1, while the traveling body 1 is traveling by the magnetic-tape traveling method. In addition, the position detector 112 detects the position of the traveling body 1 while the traveling body 1 is traveling by the guideless traveling method. The position detector 112 is an example of the position detector according to the present disclosure. The position detector 112 detects the position (coordinates) of the traveling body 1 on the map in the environment map 122. For example, the position detector 112 detects the position on the map of the environment map 122, based on the distance to the obstacle WD measured by the distance sensor 13 at a predetermined time interval. A well-known method can be adopted as the position detection method. The position detector 112 registers the detected position information of the traveling body 1 in the position information 123 (see FIG. 3).

The determination processor 113 determines the detection state of the magnetic tape MT. Further, the determination processor 113 determines whether or not the traveling body 1 is in a state where it can travel by the magnetic-tape traveling method, based on the detection state of the magnetic tape MT. The determination processor 113 is an example of a determination processor according to the present disclosure.

For example, the determination processor 113 determines whether or not the magnetic intensity detected from the magnetic tape MT is equal to or higher than a predetermined value. Then, the determination processor 113 determines that the traveling body 1 is in a state (normal state) in which the traveling body 1 can travel by the magnetic-tape traveling method when the magnetic intensity is equal to or higher than a predetermined value, and determines that the traveling body 1 is in a state (abnormal state) in which the traveling body 1 cannot travel by the magnetic-tape traveling method when the magnetic intensity is less than the predetermined value. The abnormal state occurs, for example, when the traveling body 1 is derailed from the magnetic tape MT, when the magnetic tape MT laid on the traveling route LD is interrupted, or when an abnormality occurs in a magnetic sensor (not shown) detecting magnetism of the magnetic tape MT.

Here, when the determination processor 113 determines that the detection state of the magnetic tape MT is in the normal state, the traveling controller 111 travels the traveling body 1 by the magnetic-tape traveling method. On the other hand, when the determination processor 113 determines that the detection state of the magnetic tape MT is in the abnormal state, the traveling controller 111 switches from the magnetic-tape traveling method to the guideless travel method and travels the traveling body 1. That is, for example, when the traveling body 1 is traveling on the traveling route RD by the magnetic-tape traveling method, if the traveling body 1 is derailed from the magnetic tape MT so as to be outside the traveling route RD for some reason, the traveling controller 111 switches the traveling method to the guideless traveling method.

Further, when the traveling controller 111 switches from the magnetic-tape traveling method to the guideless traveling method, it executes a process (return process) for returning to the magnetic-tape traveling method. For example, when the traveling body 1 is derailed from the magnetic tape MT, the traveling controller 111 generates a return route BR for the traveling body 1 to return to the position of the magnetic tape MT, and executes a return process for traveling the traveling body 1 along the generated return route BR.

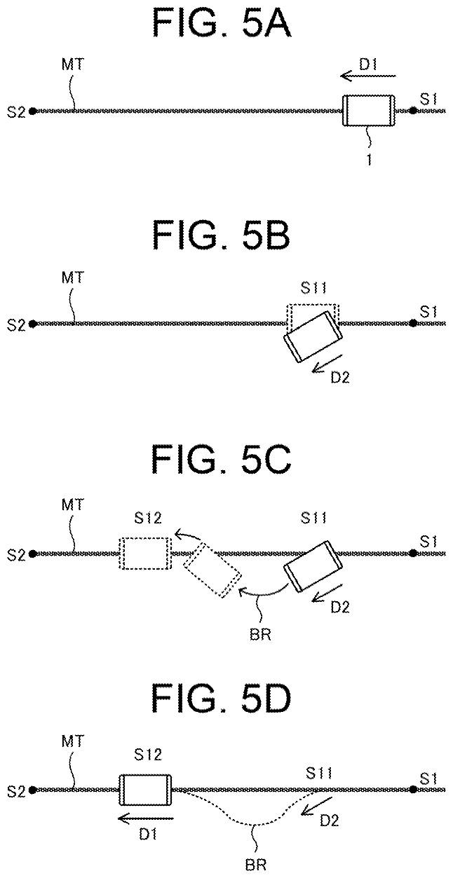

FIGS. 5A to 5D are diagrams each showing an example of the return process. For example, when the traveling body 1 is traveling in a direction D1 from an intersection S1 to an intersection S2 by the magnetic-tape traveling method (see FIG. 5A), if the traveling body 1 is derailed from the magnetic tape MT in a direction D2 at a position S11 (see FIG. 5B), the traveling controller 111 generates the return route BR (FIG. 5C). For example, the traveling controller 111 generates a return route BR, based on information regarding the position detected by the position detector 112 (see FIG. 3) and information regarding a derailment position S11 in which the traveling body 1 is derailed from the magnetic tape MT. Further, the traveling controller 111 may generate a return route BR, based on each of the above-mentioned information and information in the direction (D2) in which the traveling body 1 is derailed from the magnetic tape MT. For example, when the traveling body 1 is derailed to the left side (direction D2) with respect to the direction D1, the traveling controller 111 turns to the right side and generates a return route BR for returning to the magnetic tape MT in the shortest time or the shortest distance.

In addition, when the magnetic tape MT is laid on a straight line on the traveling route LD, if it is interrupted in the middle, the traveling body 1 is derailed in the direction D1. In this case, the traveling controller 111 generates a return route BR that goes straight in the direction D1 and returns to the magnetic tape MT.

Here, the traveling controller 111 may generate a return route BR on which the traveling body 1 is returned to the magnetic tape MT by getting the traveling body 1 back to the derailment position S11, but in order to prevent a decrease in work efficiency, it is preferred that the traveling controller 111 generate the return route BR on which the traveling body 1 is returned to the magnetic tape MT while traveling to the destination. For example, when the traveling body 1 is derailed to the left side (direction D2) with respect to the direction D1, the traveling controller 111 generates a return route BR (see FIG. 5C) on which the traveling body 1 is returned to the magnetic tape MT by turning to the right while traveling in the direction D1. That is, the traveling controller 111 generates a return route BR on which the traveling body 1 is returned to a position D12 on the traveling direction (D1) side of the magnetic tape MT, on which the traveling body 1 should travel, from the derailment position S11 of the magnetic tape MT.

The traveling controller 111 travels the traveling body 1 based on the generated return route BR. Further, the determination processor 113 determines whether or not the traveling body 1 has returned to the position of the magnetic tape MT after the traveling body 1 has been derailed from the magnetic tape MT. The traveling controller 111 switches the guideless travel method to the magnetic-tape traveling method, when the determination processor 113 determines that the traveling body 1 has returned to the position of the magnetic tape MT. For example, when the traveling controller 111 travels the traveling body 1 based on the return route BR, if the determination processor 113 determines that the traveling body 1 has returned to the position of the magnetic tape MT, the traveling controller 111 causes the traveling body 1 to travel again by the magnetic-tape traveling method (see FIG. 5D).

In addition, the traveling controller 111 stops the traveling body 1, when the traveling body 1 does not return to the position of the magnetic tape MT, even if the traveling body 1 is traveled for a predetermined time or a predetermined distance after switching to the guideless traveling method.

The obstacle detector 114 detects obstacles. For example, the obstacle detector 114 detects an obstacle in the obstacle detection range AR (see FIG. 7 etc.) based on a measurement result of the distance sensor 13. When the obstacle is detected by the obstacle detector 114, the traveling controller 111 stops the traveling body 1 or travels it at a low speed. Further, the traveling controller 111 may travel the traveling body 1 so as to avoid the obstacle.

The output processor 115 outputs information representing the traveling state of the traveling body 1. For example, when the traveling body 1 is derailed from the magnetic tape MT, the output processor 115 controls the informer 14 to inform of a warning representing that the derailment has occurred. Further, for example, when the traveling body 1 is derailed from the magnetic tape MT and cannot return, the output processor 115 controls the informer 14 to inform of a warning representing that the traveling body 1 cannot travel. When the informer 14 is a display panel, the output processor 115 causes the display panel to display a message corresponding to the warning.

### Traveling Control Process

A traveling control process to be executed in the traveling body 1 will be described with reference to FIG. 6 below. Specifically, in the present embodiment, the traveling control process is executed by the controller 11 of the traveling body 1. Further, the controller 11 starts the traveling control process when the traveling body 1 starts traveling. Further, the controller 11 ends the traveling control process, when the traveling of the traveling body 1 is completed (stopped).

The present disclosure can be regarded as a disclosure of a traveling control method for executing one or a plurality of steps included in the traveling control process. Furthermore, one or a plurality of the steps included in the traveling control process described here may be omitted where necessary. Moreover, the steps of the traveling control process may be executed in a different order as long as the same effect is obtained. In addition, descriptions will hereinafter be made to a case where each of the steps of the traveling control process is executed by the controller 11, by way of example. However, in another embodiment, each of the steps of the traveling control method may be executed in a distributed fashion by a plurality of processors.

Here, it is assumed that a predetermined traveling route RD (see FIG. 4) is generated by the controller 11 before the traveling body 1 starts traveling (at the time of initial setting).

When the traveling body 1 starts traveling along the traveling route RD, first, in step S11, the controller 11 causes the traveling body 1 to travel along the magnetic tape MT by the magnetic-tape traveling method. The controller 11 detects the position (current position) of the traveling body 1 on the map in the environment map 122 while the traveling body 1 is traveling along the magnetic tape MT. The controller 11 detects the position while the traveling body 1 is traveling, and registers the detected position information in the position information 123. Step S11 is an example of the traveling control step and the position detection step of the present invention.

Next, in Step S12, the controller 11 determines whether or not the traveling body 1 has been derailed from the magnetic tape MT. For example, the controller 11 determines that the traveling body 1 has been derailed from the magnetic tape MT, when the magnetic intensity detected from the magnetic tape MT is less than a predetermined value. When the controller 11 determines that the traveling body 1 has been derailed from the magnetic tape MT (S12: Yes), the process shifts to Step S13. If the controller 11 does not determine that the traveling body 1 has been derailed from the magnetic tape MT (S12: No), the process returns to Step S11. That is, while the traveling body 1 normally travels along the magnetic tape MT by the magnetic-tape traveling method, the processes of Steps S11 to S12 are repeated. Step S12 is an example of a determination step of the present disclosure.

In Step S13, the controller 11 switches from the magnetic-tape traveling method to the guideless traveling method. For example, when the traveling body 1 is traveling in the direction D1 from the intersection S1 to the intersection S2 by the magnetic-tape traveling method (see FIG. 5A), if the traveling body 1 is derailed from the magnetic tape MT in the direction D2 at the position S11 (see FIG. 5B), the controller 11 switches from the magnetic-tape traveling method to the guideless traveling method.

Next, in Step S14, the controller 11 generates a return route BR for returning from the guideless travel method to the magnetic-tape traveling method. For example, the controller 11 generates a return route BR (see FIG. 5C), based on the position information 123 (see FIG. 3), the information regarding the derailment position S11, and information regarding the derailment direction (D2).

Next, in Step S15, the controller 11 travels the traveling body 1 based on the generated return route BR. Step S15 is an example of a traveling control step of the present disclosure.

Next, in Step S16, the controller 11 determines whether or not the traveling body 1 has returned to the magnetic tape MT. For example, the controller 11 determines that the traveling body 1 has returned to the magnetic tape MT, when the magnetic intensity detected from the magnetic tape MT exceeds a predetermined value. The traveling body 1 returns to the magnetic tape MT (S16: Yes) until a predetermined time elapses since the traveling body 1 is derailed from the magnetic tape MT (S17: No), the process returns to Step S11, and the controller 11 switches the method to the magnetic-tape traveling method to travel the traveling body 1 (see FIG. 5D). The controller 11 repeats the above-mentioned process while the traveling body 1 is traveling. Step S16 is an example of a determination step of the present disclosure.

On the other hand, if the traveling body 1 cannot return to the magnetic tape MT within a predetermined time since the traveling body 1 is derailed from the magnetic tape MT (S16: No, S17: Yes), the process shifts to Step S18.

In Step S18, the controller 11 stops the traveling body 1. Step S18 is an example of the traveling control step of the present invention.

Next, in Step S19, the controller 11 controls the informer 14 to inform of a warning representing that the traveling body 1 cannot travel. As described above, the traveling control process is executed.

According to the traveling body 1 of the present embodiment, when the traveling body 1 traveling by the magnetic-tape traveling method is derailed from the magnetic tape MT, the traveling body 1 executes a return process for returning to the magnetic tape MT by the guideless traveling method. Further, in the guideless traveling method, the traveling body 1 executes the return process based on the position information 123 (see FIG. 3) detected by a self-position estimation process during traveling in the magnetic-tape traveling method. Therefore, the traveling body 1 can be returned to the magnetic tape MT in a short time. In addition, the traveling body 1 can be returned to the magnetic tape MT based on the return route BR according to the traveling direction. Therefore, when the traveling body 1 is derailed from the magnetic tape MT, the traveling body 1 can be efficiently returned.

In addition, the traveling body 1 may determine whether or not the traveling body 1 has been derailed from the traveling route RD during traveling by the guideless traveling method. In this case, when the traveling body 1 is derailed from the traveling route RD, the controller 11 executes the return process for searching for the magnetic tape MT by the guideless traveling method, and when the traveling body 1 is returned to the magnetic tape MT, it restarts traveling by the guideless traveling method.

The present disclosure is not limited to the above-described embodiment. Other embodiments will be described below.

As another embodiment, the obstacle detector 114 may make a first obstacle detection range AR1 and a second obstacle detection range AR2 different from each other. Note that the range AR1 corresponds to the magnetic-tape traveling method, while the range AR2 corresponds to the guideless traveling method. The first obstacle detection range AR1 and the second obstacle detection range AR2 include a low speed range A1, in which the traveling body 1 travels at low speed when an obstacle is detected, and include also a stop range A2 for stopping the traveling body 1 when an obstacle is detected. The low speed range A1 is set wider than the stop range A2. For example, the obstacle detector 114 sets the first obstacle detection range AR1 to a specific range including the front of the traveling body 1, as shown in FIG. 7A, and sets the second obstacle detection range AR2 to a range that surrounds the entire circumference of the traveling body 1, as shown in FIG. 7B. For example, when the determination processor 113 determines that the traveling body 1 has been derailed from the magnetic tape MT, the obstacle detector 114 switches the obstacle detection range from the first obstacle detection range AR1 to the second obstacle detection range AR2. In this way, when the traveling body 1 is derailed from the magnetic tape MT, the traveling body 1 can perform an operation for returning to the magnetic tape MT safely and efficiently by setting the obstacle detection range to a range around the traveling body 1. The first obstacle detection range AR1 is one example of the first detection range of the present invention, while the second obstacle detection range AR2 is one example of the second detection range of the present invention.

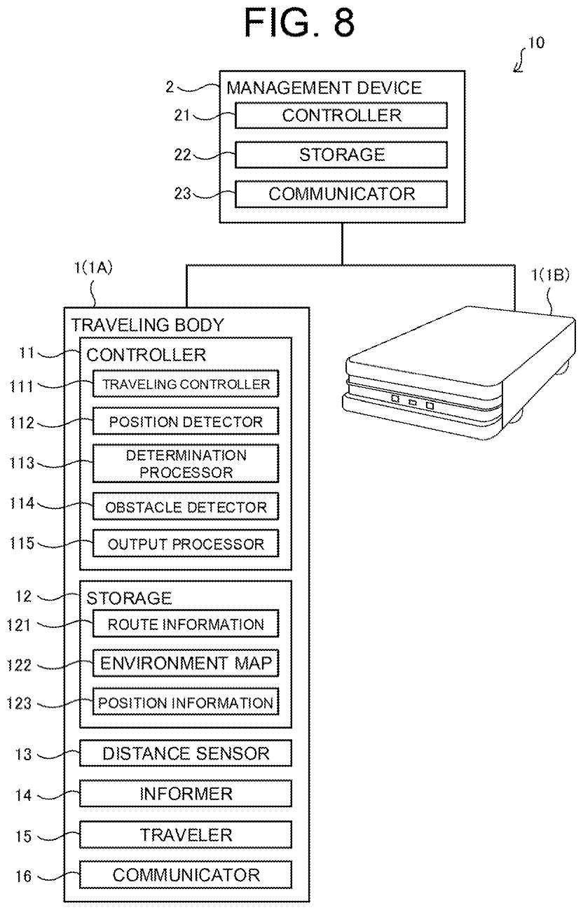

As another embodiment, as shown in FIG. 8, a traveling system 10 may be structured to include a plurality of traveling bodies 1 and a management device 2 for managing the plurality of traveling bodies 1. The management device 2 is configured to be able to communicate with each traveling body 1 via the communicator 23. FIG. 8 shows two traveling bodies 1A and 1B by way of example, but the number of traveling bodies 1 is not limited. The traveling body 1A and the traveling body 1B following the traveling body 1A will hereinafter be described as an example. The traveling system 10 is one example of the traveling system of the present invention. A traveling body 1A is one example of the first traveling body of the present invention, and a traveling body 1B is one example of the second traveling body of the present invention.

For example, the management device 2 outputs a traveling instruction to the traveling body 1B based on information acquired from the traveling body 1A, and outputs a traveling instruction to the traveling body 1A based on the information acquired from the traveling body 1B. The traveling bodies 1A and 1B may have the same configuration. That is, in each of the traveling bodies 1A and 1B, the position detector 112 detects the position of the traveling body, the determination processor 113 determines whether or not the traveling body has been derailed from the magnetic tape MT, and the traveling controller 111 controls the traveling body to return to the magnetic tape MT when the traveling body is derailed therefrom.

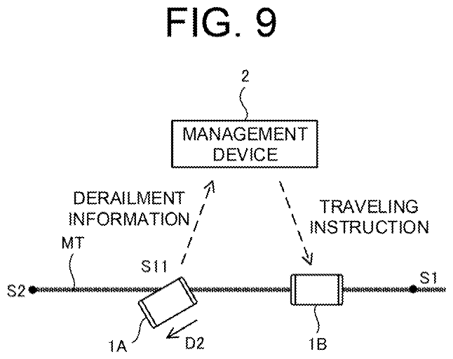

For example, when the traveling body 1A is derailed from the magnetic tape MT (see FIG. 9), the output processor 115 of the traveling body 1A transmits information (derailment information) representing the derailment to the management device 2. The derailment information includes information such as the derailed position (derailment position S11), the direction (derailment direction D2), and the time (derailment time). When the controller 21 of the management device 2 receives the derailment information from the traveling body 1A, the controller 21 outputs information corresponding to the derailment information, for example, information regarding the derailment position S11 and a traveling instruction to switch to low-speed traveling from the front of the derailment position S11, to the traveling body 1B.

Upon reception of the information regarding the derailment position S11 and the traveling instruction, the traveling controller 111 of the traveling body 1B switches the traveling speed of the traveling body 1B to a low speed and controls the traveling body 1B to travel, when the traveling body 1B reaches a predetermined position based on, for example, the position information detected by the position detector 112.

Further, when the traveling body 1B is traveling at the low speed based on the traveling instruction, the determination processor 113 of the traveling body 1B determines whether the traveling body 1B is derailed at the derailment position S11 where the traveling body 1A is derailed from the magnetic tape MT. Then, when the traveling body 1B is not derailed at the derailment position S11, the controller 21 of the management device 2 outputs a traveling instruction to switch from the low speed traveling to the normal traveling, to the traveling body 1B. When the traveling controller 111 of the traveling body 1B receives the traveling instruction, it switches the traveling speed of the traveling body 1B to the normal speed and controls the traveling body 1B to travel.

On the other hand, when the traveling body 1B is derailed at the derailment position S11, the controller 21 of the management device 2 outputs a stop instruction and a warning to the traveling body 1B to stop the traveling. The traveling controller 111 of the traveling body 1B stops the traveling body 1B. Further, the output processor 115 of the traveling body 1B controls the informer 14 to inform of a warning representing that the traveling body cannot travel, for example.

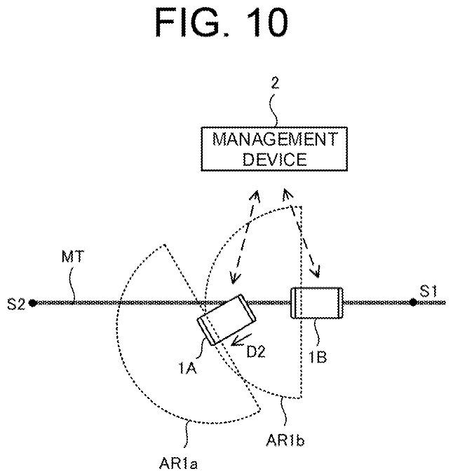

As another embodiment, for example, as shown in FIG. 10, when the traveling body 1A is derailed from the magnetic tape MT, the management device 2 may execute an obstacle detection process in the obstacle detection range of the traveling body 1B that supplements the rear of the traveling body 1A. FIG. 10 shows an obstacle detection range AR1a of the traveling body 1A and an obstacle detection range AR1b of the traveling body 1B. For example, each of the obstacle detection ranges AR1a and AR1b is set to a range of 180 degrees in front of each of the traveling bodies 1A and 1B. When the traveling body 1A is not derailed from the magnetic tape MT, the traveling body 1A detects an obstacle in the obstacle detection range AR1a, and the traveling body 1B detects an obstacle in the obstacle detection range AR1b.

On the contrary, when the traveling body 1A is derailed from the magnetic tape MT (see FIG. 10), the traveling body 1A detects an obstacle in the obstacle detection ranges AR1a and AR1b. Specifically, when the traveling body 1A is derailed from the magnetic tape MT, the obstacle detector 114 of the traveling body 1B transmits detection information about the obstacle in the obstacle detection range AR1b to the management device 2. Then, when the controller 21 of the management device 2 acquires the detection information, the controller 21 transmits the information corresponding to the detection information to the traveling body 1A. For example, when the obstacle detector 114 of the traveling body 1B detects an obstacle in the obstacle detection range AR1b, the controller 21 of the management device 2 transmits a traveling instruction to the traveling body 1A to switch to low-speed driving. When the traveling controller 111 of the traveling body 1A receives the traveling instruction from the management device 2, it switches to low-speed traveling. In this way, when the preceding traveling body 1A is derailed, the following traveling body 1B compensates for the blind spot (in this case, the rear part) of the traveling body 1A, so that the return process of the traveling body 1A can be executed safely and efficiently.

The obstacle detection range AR1a is one example of the first detection range of the present disclosure, while the obstacle detection range AR1b is one example of the second detection range of the present invention. Further, the obstacle detector 114 of the traveling body 1A is one example of the first obstacle detector of the present invention, while the obstacle detector 114 of the traveling body 1B is one example of the second obstacle detector of the present disclosure.

The above-mentioned traveling system 10 does not have to include the management device 2. That is, each of the plurality of traveling bodies 1 may control their own traveling by exchanging various information such as the derailment information and the detection information with each other. Further, in the above-mentioned traveling system 10, each of the processors included in the controller 11 of each traveling body 1 may partly or entirely be included in the controller 21 of the management device 2. Examples of the processor are the traveling controller 111, the position detector 112, the determination processor 113, the obstacle detector 114, and the output processor 115.

The traveling body of the present disclosure is not limited to a traveling car and a transport car (vehicle). That is, the traveling body of the present disclosure includes any moving body having a configuration capable of switching between the magnetic-tape traveling method and the guideless traveling method. Further, the guide member of the present disclosure is not limited to the magnetic tape, and may be a light emitting member (light emitting tape) that emits light of a predetermined wavelength, a colored member (color tape) that is colored with a predetermined color, or the like. That is, the first traveling method of the present disclosure includes various guide traveling methods in which the traveling body 1 is traveled by using a medium for traveling guides. On the other hand, the second traveling method of the present disclosure includes a guideless traveling method that does not require a medium for the traveling guide.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. A traveling body comprising:
a position detector that detects a position of the traveling body while the traveling body is traveling;
a traveling controller that switches between a first traveling method in which the traveling body is made to travel along a guide member laid on a traveling route by detecting the guide member and a second traveling method in which the traveling body is made to travel based on the position detected by the position detector without depending on the guide member; and
a determination processor that determines a detection state of the guide member, wherein
when the determination processor determines that the detection state of the guide member is a state in which the traveling body cannot travel by the first traveling method, the traveling controller switches from the first traveling method to the second traveling method.

2. The traveling body according to claim 1, wherein
the determination processor determines whether or not the traveling body has been derailed from the guide member based on the detection state of the guide member, and
when the determination processor determines that the traveling body has been derailed from the guide member, the traveling controller causes the traveling body to travel by the second traveling method and to return to the position of the guide member.

3. The traveling body according to claim 2, wherein
the position detector detects the position of the traveling body while the traveling body is traveling by the first traveling method and the position of the traveling body while the traveling body is traveling by the second traveling method, and
in the second traveling method, the traveling controller generates a return route on which the traveling body is returned to the position of the guide member to travel the traveling body along the generated return route, based on the information regarding the position detected by the position detector and information regarding a derailment position where the traveling body is derailed from the guide member.

4. The traveling body according to claim 3, wherein
the traveling controller further generates the return route based on information regarding a direction in which the traveling body is derailed from the guide member.

5. The traveling body according to claim 3, wherein
the traveling controller generates the return route for returning the traveling body to a position on a traveling direction side where the traveling body should travel, rather than the derailment position of the guide member.

6. The traveling body according to claim 2, wherein
the determination processor determines whether or not the traveling body has returned to the position of the guide member after the traveling body has been derailed from the guide member, and
when the determination processor determines that the traveling body has returned to the position of the guide member, the traveling controller switches from the second traveling method to the first traveling method.

7. The traveling body according to claim 1, further comprising
an obstacle detector that sets a detection range around the traveling body and detects an obstacle in the detection range, and wherein
the obstacle detector causes a first detection range corresponding to the first traveling method and a second detection range corresponding to the second traveling method to be different from each other.

8. The traveling body according to claim 7, wherein
the obstacle detector sets the first detection range to a specific range including the front of the traveling body, and sets the second detection range to a range that surrounds an entire circumference of the traveling body.

9. The traveling body according to claim 2, wherein
the traveling controller stops the traveling body when the traveling body does not return to the position of the guide member even if the traveling body is caused to travel for a predetermined time or a predetermined distance after switching to the second traveling method.

10. A traveling system comprising:
a position detector that detects a position of a first traveling body while the first traveling body travels along a guide member laid on a traveling route;
a determination processor that determines whether or not the first traveling body has been derailed from the guide member;
a traveling controller that controls the first traveling body to return to a position of the guide member, when the determination processor determines that the first traveling body has been derailed from the guide member; and
an output processor that outputs information regarding a derailment position where the first traveling body has been derailed from the guide member and an instruction to switch to low-speed traveling, to a second traveling body following the first traveling body, when the determination processor determines that the first traveling body has been derailed from the guide member.

11. The traveling system according to claim 10, wherein
the determination processor determines whether the second traveling body has been derailed at the derailment position where the first traveling body has been derailed from the guide member, when the second traveling body is traveling at the low speed based on the instruction, and
the output processor outputs an instruction to switch from the low-speed traveling to normal traveling to the second traveling body when the determination processor determines that the second traveling body is not derailed at the derailment position, and outputs an instruction to stop the traveling to the second traveling body, when the determination processor determines that the second traveling body has been derailed at the derailment position.

12. The driving system according to claim 10, further comprising:
a first obstacle detector that detects an obstacle in a first detection range around the first traveling body; and
a second obstacle detector that detects an obstacle in a second detection range around the second traveling body, and wherein
when the first traveling body is not derailed from the guide member, the traveling controller travels the first traveling body based on detection information detected by the first obstacle detector, whereas when the traveling body is derailed from the guide member, the traveling controller travels the first traveling body based on the detection information detected by the first obstacle detector and detection information detected by the second obstacle detector.

13. A traveling control method to be executed by one or a plurality of processors, the method comprising:
detecting a position of a traveling body while the traveling body travels;
controlling switching between a first traveling method for traveling the traveling body along a guide member laid on a traveling route by detecting a guide member and a second traveling method for traveling the traveling body based on the position detected by the detecting without depending on the guide member; and
determining a detection state of the guide member, and wherein
in the controlling, when it is determined by the determining that the detection state of the guide member is a state in which the traveling body cannot travel by the first traveling method, the first traveling method is switched to the second traveling method.
